(19) United States
(12) Patent Application Publication
(10) Pub. No.: US 2024/0405933 A1
(43) Pub. Date: Dec. 5, 2024

(54) CONFIGURING TRANSMISSION CONFIGURATION INDICATOR STATES

(71) Applicant: LENOVO (BEIJING) LIMITED, Beijing (CN)

(72) Inventors: Chenxi Zhu, Fairfax, VA (US); Bingchao Liu, Beijing (CN); Yi Zhang, Beijing (CN); Wei Ling, Beijing (CN); Lingling Xiao, Beijing (CN)

(21) Appl. No.: 18/695,433

(22) PCT Filed: Sep. 29, 2021
(86) PCT No.: PCT/CN2021/121687

§ 371 Date: Mar. 26, 2024

(51) Int. Cl. H04L 5/00; H04B 7/06; H04W 72/23

(52) U.S. Cl. CPC H04L 5/0035; H04B 7/0626; H04B 7/06968; H04W 72/23

(57) ABSTRACT

Apparatuses, methods, and systems are disclosed for configuring transmission configuration indicator states. One method (500) includes receiving (502), at a user equipment, at least one radio resource control message that configures at least one transmission configuration indicator state. A transmission configuration indicator state of the at least one transmission configuration indicator state is used as a reference for reception of a downlink signal, transmission of an uplink signal, or a combination thereof. The method (500) includes receiving (504) a medium access control control element that activates a subset of transmission configuration indicator states of the at least one transmission configuration indicator state for use by downlink control information. The method (500) includes receiving (506) the downlink control information. The downlink control information indicates a transmission configuration indicator state of the at least one transmission configuration indicator state.

### FIELD

The subject matter disclosed herein relates generally to wireless communications and more particularly relates to configuring transmission configuration indicator states.

### BACKGROUND

In certain wireless communications networks, transmission configuration indicator states may have limited functionality. In such networks, there may be configurations that are not attainable.

### BRIEF SUMMARY

Methods for configuring transmission configuration indicator states are disclosed. Apparatuses and systems also perform the functions of the methods. In one embodiment, the method includes receiving, at a user equipment, at least one radio resource control message that configures at least one transmission configuration indicator state. A transmission configuration indicator state of the at least one transmission configuration indicator state is used as a reference for reception of a downlink signal, transmission of an uplink signal, or a combination thereof. In certain embodiments, the method includes receiving a medium access control control element that activates a subset of transmission configuration indicator states of the at least one transmission configuration indicator state for use by downlink control information. In some embodiments, the method includes receiving the downlink control information. The downlink control information indicates a transmission configuration indicator state of the at least one transmission configuration indicator state.

An apparatus for configuring transmission configuration indicator states, in one embodiment, includes a user equipment. In some embodiments, the apparatus includes a receiver that: receives at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; receives a medium access control control element that activates a subset of transmission configuration indicator states of the at least one transmission configuration indicator state for use by downlink control information; and receives the downlink control information. The downlink control information indicates a transmission configuration indicator state of the at least one transmission configuration indicator state.

In various embodiments, a method for configuring transmission configuration indicator states includes transmitting, from a network device, at least one radio resource control message that configures at least one transmission configuration indicator state. A transmission configuration indicator state of the at least one transmission configuration indicator state is used as a reference for reception of a downlink signal, transmission of an uplink signal, or a combination thereof. In some embodiments, the method includes transmitting a medium access control control element that activates a subset of transmission configuration indicator states of the at least one transmission configuration indicator state for use by downlink control information. In certain embodiments, the method includes transmitting the downlink control information. The downlink control information indicates a transmission configuration indicator state of the at least one transmission configuration indicator state.

In some embodiments, an apparatus for configuring transmission configuration indicator states includes a network device. In such embodiments, the apparatus includes a transmitter that: transmits at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; transmits a medium access control control element that activates a subset of transmission configuration indicator states of the at least one transmission configuration indicator state for use by downlink control information; and transmits the downlink control information. The downlink control information indicates a transmission configuration indicator state of the at least one transmission configuration indicator state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring transmission configuration indicator states;

FIG. 2 is a schematic block diagram illustrating one embodiment of an apparatus that may be used for configuring transmission configuration indicator states;

FIG. 3 is a schematic block diagram illustrating another embodiment of an apparatus that may be used for configuring transmission configuration indicator states;

FIG. 4 is a diagram illustrating one embodiment of a TCI state information element;

FIG. 5 is a schematic flow chart diagram illustrating one embodiment of a method for configuring transmission configuration indicator states; and

FIG. 6 is a schematic flow chart diagram illustrating another embodiment of a method for configuring transmission configuration indicator states.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment.” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

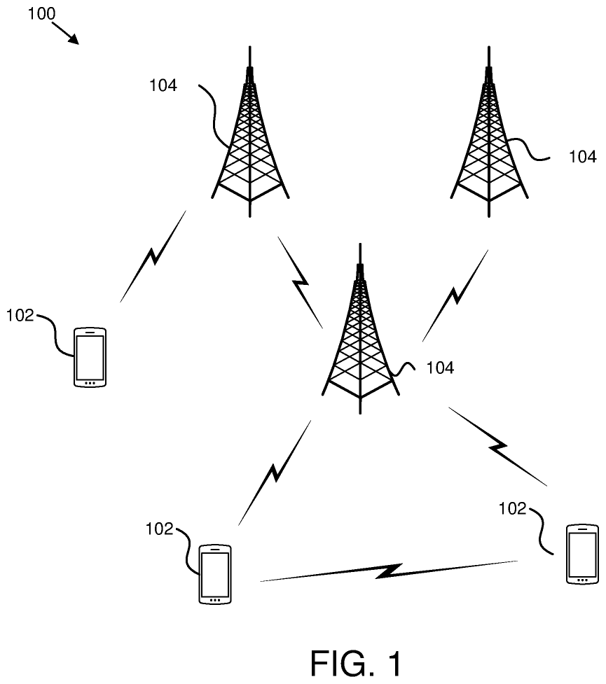

FIG. 1 depicts an embodiment of a wireless communication system 100 for configuring transmission configuration indicator states. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNodeB (“gNB”), a Home Node-B, a RAN, a relay node, a device, a network device, an integrated and access backhaul (“IAB”) node, a donor IAB node, a controller, a RIS device, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the third generation partnership program (“3GPP”) protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit downlink (“DL”) communication signals to serve the remote units 102 in the time, frequency, and/or spatial domain.

In various embodiments, a remote unit 102 may receive at least one radio resource control message that configures at least one transmission configuration indicator state. A transmission configuration indicator state of the at least one transmission configuration indicator state is used as a reference for reception of a downlink signal, transmission of an uplink signal, or a combination thereof. In certain embodiments, the remote unit 102 may receive a medium access control control element that activates a subset of transmission configuration indicator states of the at least one transmission configuration indicator state for use by downlink control information. In some embodiments, the remote unit 102 may receive the downlink control information. The downlink control information indicates a transmission configuration indicator state of the at least one transmission configuration indicator state. Accordingly, a remote unit 102 may be used for configuring transmission configuration indicator states.

In some embodiments, a network unit 104 may transmit at least one radio resource control message that configures at least one transmission configuration indicator state. A transmission configuration indicator state of the at least one transmission configuration indicator state is used as a reference for reception of a downlink signal, transmission of an uplink signal, or a combination thereof. In some embodiments, the network unit 104 may transmit a medium access control control element that activates a subset of transmission configuration indicator states of the at least one transmission configuration indicator state for use by downlink control information. In certain embodiments, the network unit 104 may transmit the downlink control information. The downlink control information indicates a transmission configuration indicator state of the at least one transmission configuration indicator state. Accordingly, a network unit 104 may be used for configuring transmission configuration indicator states.

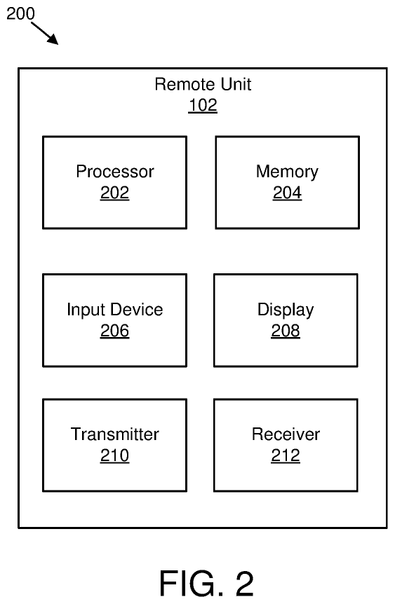

FIG. 2 depicts one embodiment of an apparatus 200 that may be used for configuring transmission configuration indicator states. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”) display, an LED display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In various embodiments, receiver 212: receives at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; receives a medium access control control element that activates a subset of transmission configuration indicator states of the at least one transmission configuration indicator state for use by downlink control information; and receives the downlink control information. The downlink control information indicates a transmission configuration indicator state of the at least one transmission configuration indicator state.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

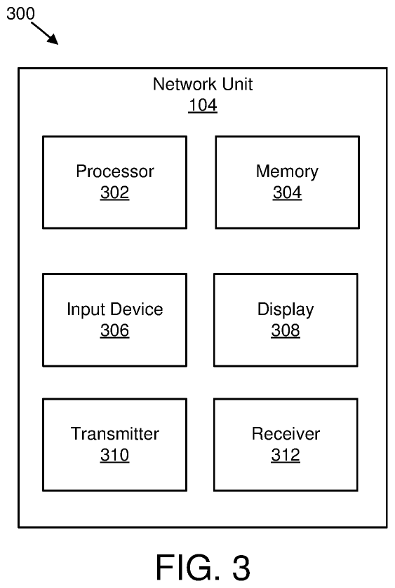

FIG. 3 depicts another embodiment of an apparatus 300 that may be used for configuring transmission configuration indicator states. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the transmitter 310: transmits at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; transmits a medium access control control element that activates a subset of transmission configuration indicator states of the at least one transmission configuration indicator state for use by downlink control information; and transmits the downlink control information. The downlink control information indicates a transmission configuration indicator state of the at least one transmission configuration indicator state.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, a transmission configuration indicator (“TCI”) state may represent a downlink (“DL”) TCI, an uplink (“UL”) TCI, or a joint TCI. In some embodiments, a TCI state pool may be configured, and a separate DL TCI state, UL TCI state, or joint DL and/or UL TCI state may be indicated by a TCI field in downlink control information (“DCI”) (e.g., a DCI format 1_1, a DCI format 1_2) with or without a physical downlink shared channel (“PDSCH”) assignment. In such embodiments, the indicated TCI may be used to update a common TCI state for a PDSCH, a physical downlink control channel (“PDCCH”), a physical uplink shared channel (“PUSCH”), and/or a physical uplink control channel (“PUCCH”), and some DL and UL reference signals (“RSs”) may share the same TCI state with DL and/or UL channels. In various embodiments, no mechanism of a medium access control (“MAC”) control element (“CE”) (“MAC-CE”) or DCI may be used to signal to a user equipment (“UE”) whether a TCI state applies to DL, applies to UL, or applies to DL and UL jointly or separately. In certain embodiments, radio resource control (“RRC”) signaling may be used to configure TCI states accommodating different applications (e.g., DL only, UL only, joint or separate DL and/or UL).

In some embodiments, a TCI state may be configured via RRC signaling and may be for DL only. UL only, joint DL and UL, or separate DL and UL TCI. In such embodiments, if the TCI state is signaled to a UE (e.g., through MAC-CE activation and dynamic DCI indication), the UE may tell whether the TCI is for DL-only, for UL-only, or for both DL and UL. Moreover, in such embodiments, a quasi-co-colocation (“QCL”) type may be used to indicate a corresponding direction (e.g., DL, UL, or DL and UL).

In various embodiments, a TCI state in RRC signaling may be used for a unified TCI approach. In such embodiments, one or two RSs may be used for a DL QCL-TypeD receive (“RX”) spatial filter, UL spatial relation information, and/or an UL transmit (“TX”) spatial filter. In certain embodiments, there may be two new QCL types: ‘type E’: {Spatial RX parameter for DL and spatial relation information for UL}; and ‘type F’: {Spatial relation information for UL}.

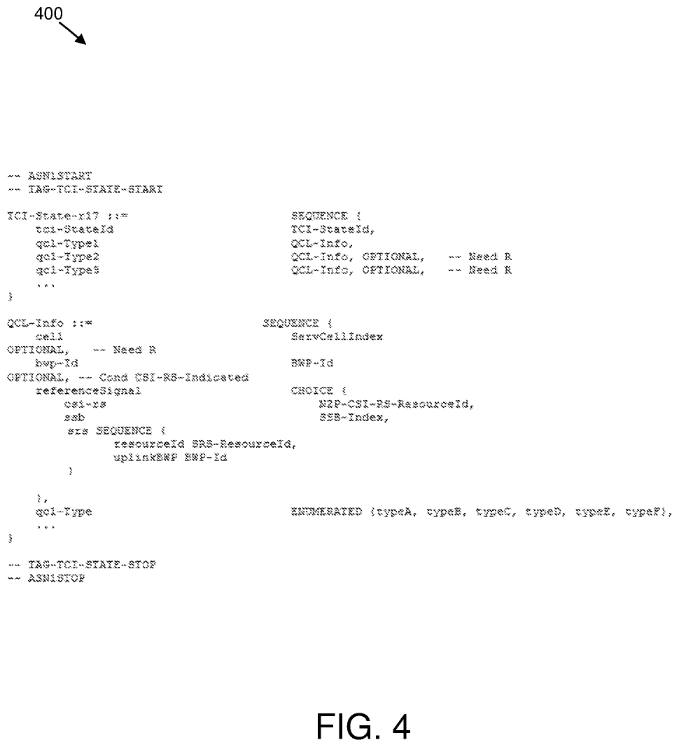

In some embodiments, a QCL-TypeE may refer to a DL signal (e.g., synchronization signal block (“SSB”) or channel state information (“CSI”) reference signal (“RS”) (“CSI-RS”)) that may be used both as a spatial RX filter for DL channel and/or signal reception and as a spatial TX filter for UL channel and/or signal transmission. In various embodiments, a QCL-TypeF may refer to a DL signal (e.g., SSB or CSI-RS) or an SSB for beam management that may be used as the spatial TX filter for UL channel and/or signal transmission. In certain embodiments, a TCI state may be defined via RRC signaling and may include up to 3 QCLs as defined in FIG. 4. Specifically, FIG. 4 is a diagram 400 illustrating one embodiment of a TCI state information element (“IE”).

In some embodiments, a TCI state may be defined for use as DL-only TCI, UL-only TCI, joint DL and UL TCL, or separate DL and UL TCI.

In various embodiments, DL-only TCI may contain one or two QCLs. If two QCLs are included, one is a QCL-TypeD as shown in Table 1.

TABLE 1

| | |
|---|---|
| TCI-State ::= | SEQUENCE { |
| tci-StateId | TCI-StateId, |
| qcl-TypeA | NZP-CSI-RS resource 1, |
| qcl-TypeD | NZP-CSI-RS resource 1 |
| } | |

In certain embodiments, a first non-zero power (“NZP”) CSI-RS (“NZP-CSI-RS) resource may be used as a QCL-TypeA resource to provide a reference for a Doppler shift, a Doppler spread, an average delay, and/or a delay spread, and the same first NZP-CSI-RS resource may be is used as a QCL-TypeD resource to provide a spatial RX parameter.

In some embodiments, a UL-only TCI contains only QCL-TypeF as shown in Table 2.

TABLE 2

| | |
|---|---|
| TCI-State ::= | SEQUENCE { |
| tci-StateId | TCI-StateId, |
| qcl-TypeF | NZP-CSI-RS resource 1 |
| } | |

In various embodiments, a first NZP-CSI-RS resource may be used to provide spatial relation information for UL transmission.

In certain embodiments, joint DL and/or UL TCI contains one or two QCLs. If two QCL are contained, one is QCL-TypeE as shown in Table 3.

TABLE 3

| | |
|---|---|
| TCI-State ::= | SEQUENCE { |
| tci-StateId | TCI-StateId, |
| qcl-TypeA | NZP-CSI-RS resource 1, |
| qcl-TypeE | NZP-CSI-RS resource 2 |
| } | |

In some embodiments, a first NZP-CSI-RS resource may be used as a QCL-TypeA resource to provide a reference to a Doppler shift, a Doppler spread, an average delay, and/or a delay spread for a DL signal and/or channel, and a second NZP-CSI-RS resource may be used as a QCL-TypeE to provide both DL RX parameter to a DL signal and/or channel and a UL spatial RX parameter to an UL signal and/or channel.

In various embodiments, separate DL and/or UL TCI contains two or three QCLs, including a QCL-TypeD for DL and a QCL-TypeE for UL as shown in Table 4.

TABLE 4

| | |
|---|---|
| TCI-State ::= | SEQUENCE { |
| tci-StateId | TCI-StateId, |
| qcl-TypeA | NZP-CSI-RS resource 1, |
| qcl-TypeD | NZP-CSI-RS resource 2, |
| qcl-TypeF | SRS resource 1 |
| } | |

In certain embodiments, a first NZP-CSI-RS resource may be used to as a QCL-TypeA resource to provide a reference to a Doppler shift, a Doppler spread, an average delay, and/or a delay spread for a DL signal and/or channel, and a second NZP-CSI-RS resource may provide a spatial RX parameter for DL signal and/or channel reception. In such embodiments, a first SRS resource may be used as a QCL-TypeF resource to provide an UL spatial RX parameter to an UL signal and/or channel.

In some embodiments, after a definition of QXL types in RRC signaling, a subset of TCI states may be activated with MAC-CE sent to a set of TCI codepoints. In such embodiments, DCI (e.g., DCI format 1_1 and/or DCI format 1_2) includes a TCI field pointing to an activated TCI codepoint of multiple TCI codepoints. In response to a TCI state being indicated by DCI (e.g., DCI format 1_1 and/or DCI format 1_2), how the TCI state is used may depend on the type of QCLs included in the TCI state. A device may apply a QCL-typeD RS to an applicable DL channel and/or signal, apply a QCL-typeF RS to an applicable UL channel and/or signal, and a QCL-TypeE RS to both an applicable DL channel and/or signal and an applicable UL channel and/or signal. If the TCI state includes both a QCL-TypeD RS and a QCL-TypeF RS, the QCL-TypeD RS is applied to the applicable DL channel and/or signal, and the QCL-TypeF RS is applied to the applicable UL channel and/or signal. If the TCI state does not include QCL that is applicable to DL or UL, a current UL or DL state may be unchanged.

In various embodiments, if applied to DL, a QCL-typeD RS or a QCL-typeE RS may apply to UE specific PDSCH and/or PDCCH in a corresponding bandwidth part (“BWP”) and/or common carrier (“CC”), and CSI-RS may not be configured or signaled via a TCI state with MAC-CE.

In some embodiments, if applied to UL, a QCL-typeF RS or a QCL-typeE RS may apply to UE specific PUSCH and/or PUCCH in a corresponding BWP/CC, and a SRS resource or resource set may not be configured or signaled via spatial relation information with MAC-CE.

In various embodiments, for DL-only, joint DL and UL, and/or separate DL and UL, there may be one additional TCI type which is not QCL-typeD or QCL-typeE. This QCL may provide a reference to reception of a DL signal other than a spatial RX parameter. Because the unified QCL may provide a reference to PDSCH and PDCCH, a QCL typeA may used to provide a Doppler shift, a Doppler spread, an average delay, and/or a delay spread to a PDSCH and/or a PDCCH.

In certain embodiments, for DL-only, separate DL and UL, and/or joint DL and UL TCI applied to PDSCH and/or PDCCH, a TCI may contain a QCL-TypeA RS and a QCL-TypeD RS (e.g., QCL-TypeE for joint DL and UL TCI). The QCL-TypeA RS may refer to a CSI-RS resource in an NZP-CSI-RS resource set (e.g., NZP-CSI-RS-ResourceSet) configured with a higher layer parameter (e.g., trs-Info). The QCL-TypeD RS (or QCL-TypeE RS) may refer to the same CSI-RS resource as the QCL-TypeA RS, or another CSI-RS resource in an NZP-CSI-RS resource set (e.g., NZP-CSI-RS-ResourceSet) configured with higher layer parameter repetition. In other embodiments, a QCL-typeA RS refers to a CSI-RS resource in an NZP-CSI-RS resource set (e.g., NZP-CSI-RS-ResourceSet) configured without a higher layer parameter (e.g., trs-Info) and without higher layer parameter repetition, and a QCL-typeD RS (or QCL-typeE RS) may refer to the same CSI-RS resource.

In some embodiments, in a UL-only TCI state, only a QCL-TypeF RS may be included. The QCL-TypeF RS may be an SSB, NZP-CSI-RS, or an SRS.

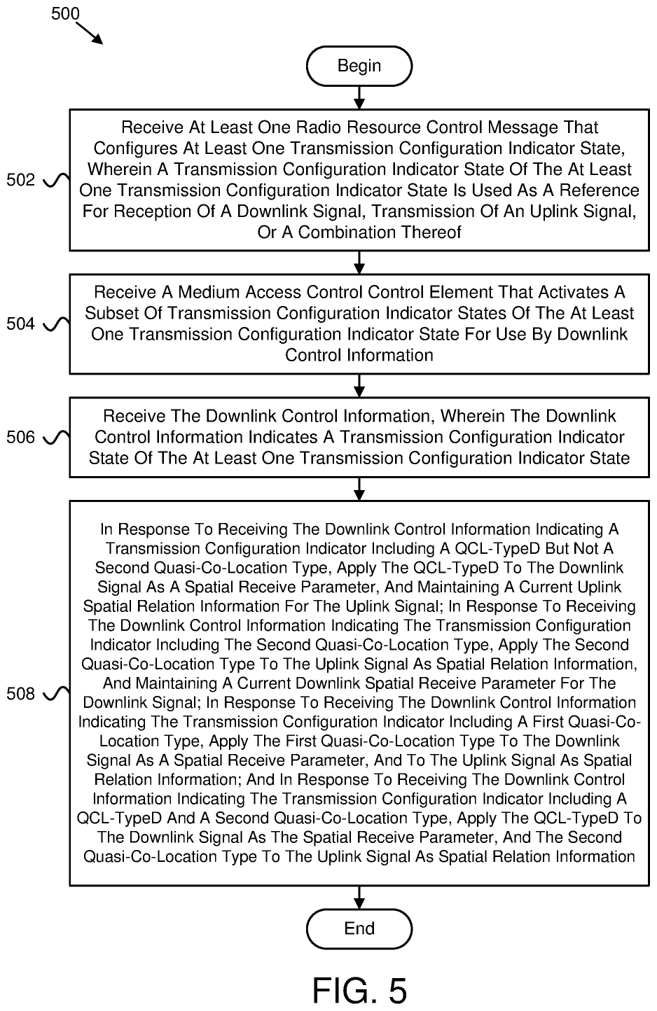

FIG. 5 is a schematic flow chart diagram illustrating one embodiment of a method 500 for configuring transmission configuration indicator states. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

The method 500 may include receiving 502 at least one radio resource control message that configures at least one transmission configuration indicator state. A transmission configuration indicator state of the at least one transmission configuration indicator state is used as a reference for reception of a downlink signal, transmission of an uplink signal, or a combination thereof. In certain embodiments, the method 500 includes receiving 504 a medium access control control element that activates a subset of transmission configuration indicator states of the at least one transmission configuration indicator state for use by downlink control information. In some embodiments, the method 500 includes receiving 506 the downlink control information. The downlink control information indicates a transmission configuration indicator state of the at least one transmission configuration indicator state.

In certain embodiments, the transmission configuration indicator state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

In some embodiments, the method 500 further comprises: in response to receiving the downlink control information indicating a transmission configuration indicator including the QCL-TypeD but not the second quasi-co-location type, applying 508 the QCL-TypeD to the downlink signal as a spatial receive parameter, and maintaining a current uplink spatial relation information for the uplink signal; in response to receiving the downlink control information indicating the transmission configuration indicator including the second quasi-co-location type, applying the second quasi-co-location type to the uplink signal as spatial relation information, and maintaining a current downlink spatial receive parameter for the downlink signal; in response to receiving the downlink control information indicating the transmission configuration indicator including the first quasi-co-location type, applying the first quasi-co-location type to the downlink signal as a spatial receive parameter, and to the uplink signal as spatial relation information; and in response to receiving the downlink control information indicating the transmission configuration indicator including a QCL-TypeD and a second quasi-co-location type, applying the QCL-TypeD to the downlink signal as the spatial receive parameter, and the second quasi-co-location type to the uplink signal as spatial relation information.

In various embodiments, the downlink signal comprises a user equipment dedicated physical downlink shared channel and physical downlink control channel in a corresponding bandwidth part, a corresponding component carrier, or a combination thereof and a channel state information reference signal that is not configured or signaled in the transmission configuration indicator state via the medium access control control element. In one embodiment, the uplink signal comprises a user equipment dedicated physical uplink data channel and physical uplink control channel in a corresponding bandwidth part, a corresponding component carrier, or a combination thereof and a sounding reference signal resource or resource set that is not configured or signaled spatial relation information via the medium access control control element.

In certain embodiments, a QCL-TypeA is included with the QCL-TypeD or the first quasi-co-location type, the QCL-TypeA is a non-zero power channel state information reference signal resource with parameter trs-info, or without trs-info and without repetition, the QCL-TypeD comprises a QCL-TypeA non-zero power channel state information reference signal resource, or a non-zero power channel state information reference signal resource with repetition. In some embodiments, the second quasi-co-location type comprises a synchronization signal block, a non-zero power channel state information reference signal, or a sounding reference signal. In various embodiments, the first quasi-co-location type, the QCL-TypeD, or a combination thereof comprises a non-zero power channel state information reference signal.

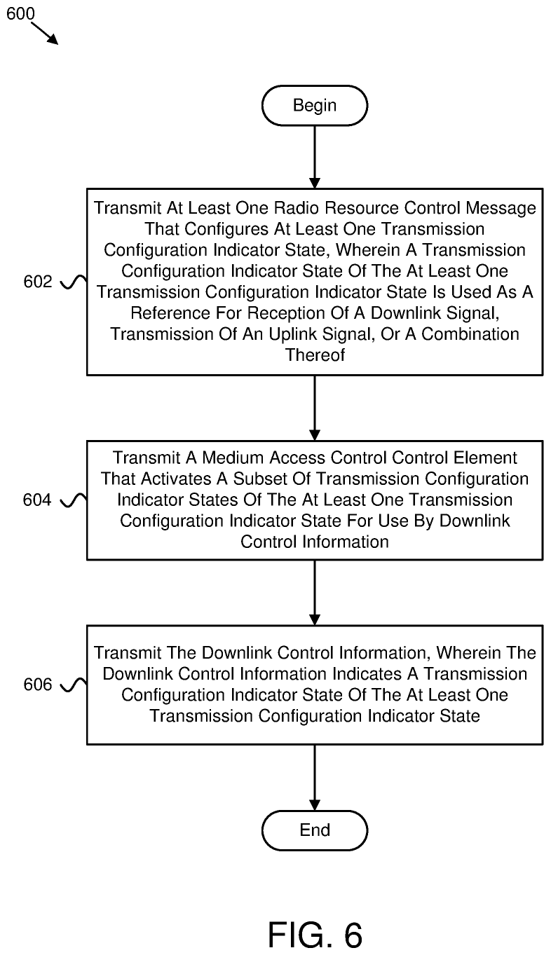

FIG. 6 is a schematic flow chart diagram illustrating another embodiment of a method 600 for configuring transmission configuration indicator states. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

The method 600 may include transmitting 602 at least one radio resource control message that configures at least one transmission configuration indicator state. A transmission configuration indicator state of the at least one transmission configuration indicator state is used as a reference for reception of a downlink signal, transmission of an uplink signal, or a combination thereof. In some embodiments, the method 600 includes transmitting 604 a medium access control control element that activates a subset of transmission configuration indicator states of the at least one transmission configuration indicator state for use by downlink control information. In certain embodiments, the method 600 includes transmitting 606 the downlink control information. The downlink control information indicates a transmission configuration indicator state of the at least one transmission configuration indicator state.

In certain embodiments, the transmission configuration indicator state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission. In some embodiments, the downlink signal comprises a user equipment dedicated physical downlink shared channel and physical downlink control channel in a corresponding bandwidth part, a corresponding component carrier, or a combination thereof and a channel state information reference signal that is not configured or signaled in the transmission configuration indicator state via the medium access control control element.

In various embodiments, the uplink signal comprises a user equipment dedicated physical uplink data channel and physical uplink control channel in a corresponding bandwidth part, a corresponding component carrier, or a combination thereof and a sounding reference signal resource or resource set that is not configured or signaled spatial relation information via the medium access control control element. In one embodiment, a QCL-TypeA is included with the QCL-TypeD or the first quasi-co-location type, the QCL-TypeA is a non-zero power channel state information reference signal resource with parameter trs-info, or without trs-info and without repetition, the QCL-TypeD comprises a QCL-TypeA non-zero power channel state information reference signal resource, or a non-zero power channel state information reference signal resource with repetition.

In certain embodiments, the second quasi-co-location type comprises a synchronization signal block, a non-zero power channel state information reference signal, or a sounding reference signal. In some embodiments, the first quasi-co-location type, the QCL-TypeD, or a combination thereof comprises a non-zero power channel state information reference signal.

In one embodiment, a method of a user equipment comprises: receiving at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; receiving a medium access control control element that activates a subset of transmission configuration indicator states of the at least one transmission configuration indicator state for use by downlink control information; and receiving the downlink control information, wherein the downlink control information indicates a transmission configuration indicator state of the at least one transmission configuration indicator state.

In certain embodiments, the transmission configuration indicator state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

In some embodiments, the method further comprises: in response to receiving the downlink control information indicating a transmission configuration indicator including the QCL-TypeD but not the second quasi-co-location type, applying the QCL-TypeD to the downlink signal as a spatial receive parameter, and maintaining a current uplink spatial relation information for the uplink signal; in response to receiving the downlink control information indicating the transmission configuration indicator including the second quasi-co-location type, applying the second quasi-co-location type to the uplink signal as spatial relation information, and maintaining a current downlink spatial receive parameter for the downlink signal; in response to receiving the downlink control information indicating the transmission configuration indicator including the first quasi-co-location type, applying the first quasi-co-location type to the downlink signal as a spatial receive parameter, and to the uplink signal as spatial relation information; and in response to receiving the downlink control information indicating the transmission configuration indicator including a QCL-TypeD and a second quasi-co-location type, applying the QCL-TypeD to the downlink signal as the spatial receive parameter, and the second quasi-co-location type to the uplink signal as spatial relation information.

In various embodiments, the downlink signal comprises a user equipment dedicated physical downlink shared channel and physical downlink control channel in a corresponding bandwidth part, a corresponding component carrier, or a combination thereof and a channel state information reference signal that is not configured or signaled in the transmission configuration indicator state via the medium access control control element.

In one embodiment, the uplink signal comprises a user equipment dedicated physical uplink data channel and physical uplink control channel in a corresponding bandwidth part, a corresponding component carrier, or a combination thereof and a sounding reference signal resource or resource set that is not configured or signaled spatial relation information via the medium access control control element.

In certain embodiments, a QCL-TypeA is included with the QCL-TypeD or the first quasi-co-location type, the QCL-TypeA is a non-zero power channel state information reference signal resource with parameter trs-info, or without trs-info and without repetition, the QCL-TypeD comprises a QCL-TypeA non-zero power channel state information reference signal resource, or a non-zero power channel state information reference signal resource with repetition.

In some embodiments, the second quasi-co-location type comprises a synchronization signal block, a non-zero power channel state information reference signal, or a sounding reference signal.

In various embodiments, the first quasi-co-location type, the QCL-TypeD, or a combination thereof comprises a non-zero power channel state information reference signal.

In one embodiment, an apparatus comprises a user equipment. The apparatus further comprises: a receiver that: receives at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; receives a medium access control control element that activates a subset of transmission configuration indicator states of the at least one transmission configuration indicator state for use by downlink control information; and receives the downlink control information, wherein the downlink control information indicates a transmission configuration indicator state of the at least one transmission configuration indicator state.

In certain embodiments, the transmission configuration indicator state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

In some embodiments, the apparatus further comprises a processor, wherein: in response to receiving the downlink control information indicating a transmission configuration indicator including the QCL-TypeD but not the second quasi-co-location type, the processor applies the QCL-TypeD to the downlink signal as a spatial receive parameter, and the processor maintains a current uplink spatial relation information for the uplink signal; in response to receiving the downlink control information indicating the transmission configuration indicator including the second quasi-co-location type, the processor applies the second quasi-co-location type to the uplink signal as spatial relation information, and the processor maintains a current downlink spatial receive parameter for the downlink signal; in response to receiving the downlink control information indicating the transmission configuration indicator including the first quasi-co-location type, the processor applies the first quasi-co-location type to the downlink signal as a spatial receive parameter, and to the uplink signal as spatial relation information; and in response to receiving the downlink control information indicating the transmission configuration indicator including a QCL-TypeD and a second quasi-co-location type, the processor applies the QCL-TypeD to the downlink signal as the spatial receive parameter, and the second quasi-co-location type to the uplink signal as spatial relation information.

In various embodiments, the downlink signal comprises a user equipment dedicated physical downlink shared channel and physical downlink control channel in a corresponding bandwidth part, a corresponding component carrier, or a combination thereof and a channel state information reference signal that is not configured or signaled in the transmission configuration indicator state via the medium access control control element.

In one embodiment, the uplink signal comprises a user equipment dedicated physical uplink data channel and physical uplink control channel in a corresponding bandwidth part, a corresponding component carrier, or a combination thereof and a sounding reference signal resource or resource set that is not configured or signaled spatial relation information via the medium access control control element.

In certain embodiments, a QCL-TypeA is included with the QCL-TypeD or the first quasi-co-location type, the QCL-TypeA is a non-zero power channel state information reference signal resource with parameter trs-info, or without trs-info and without repetition, the QCL-TypeD comprises a QCL-TypeA non-zero power channel state information reference signal resource, or a non-zero power channel state information reference signal resource with repetition.

In some embodiments, the second quasi-co-location type comprises a synchronization signal block, a non-zero power channel state information reference signal, or a sounding reference signal.

In various embodiments, the first quasi-co-location type, the QCL-TypeD, or a combination thereof comprises a non-zero power channel state information reference signal.

In one embodiment, a method of a network device comprises: transmitting at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; transmitting a medium access control control element that activates a subset of transmission configuration indicator states of the at least one transmission configuration indicator state for use by downlink control information; and transmitting the downlink control information, wherein the downlink control information indicates a transmission configuration indicator state of the at least one transmission configuration indicator state.

In certain embodiments, the transmission configuration indicator state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

In some embodiments, the downlink signal comprises a user equipment dedicated physical downlink shared channel and physical downlink control channel in a corresponding bandwidth part, a corresponding component carrier, or a combination thereof and a channel state information reference signal that is not configured or signaled in the transmission configuration indicator state via the medium access control control element.

In various embodiments, the uplink signal comprises a user equipment dedicated physical uplink data channel and physical uplink control channel in a corresponding bandwidth part, a corresponding component carrier, or a combination thereof and a sounding reference signal resource or resource set that is not configured or signaled spatial relation information via the medium access control control element.

In one embodiment, a QCL-TypeA is included with the QCL-TypeD or the first quasi-co-location type, the QCL-TypeA is a non-zero power channel state information reference signal resource with parameter trs-info, or without trs-info and without repetition, the QCL-TypeD comprises a QCL-TypeA non-zero power channel state information reference signal resource, or a non-zero power channel state information reference signal resource with repetition.

In certain embodiments, the second quasi-co-location type comprises a synchronization signal block, a non-zero power channel state information reference signal, or a sounding reference signal.

In some embodiments, the first quasi-co-location type, the QCL-TypeD, or a combination thereof comprises a non-zero power channel state information reference signal.

In one embodiment, an apparatus comprises a network device. The apparatus further comprises: a transmitter that: transmits at least one radio resource control message that configures at least one transmission configuration indicator state, wherein a transmission configuration indicator state of the at least one transmission configuration indicator state is used as a reference for reception of a downlink signal, transmission of an uplink signal, or a combination thereof; transmits a medium access control control element that activates a subset of transmission configuration indicator states of the at least one transmission configuration indicator state for use by downlink control information; and transmits the downlink control information, wherein the downlink control information indicates a transmission configuration indicator state of the at least one transmission configuration indicator state.

In certain embodiments, the transmission configuration indicator state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

In some embodiments, the downlink signal comprises a user equipment dedicated physical downlink shared channel and physical downlink control channel in a corresponding bandwidth part, a corresponding component carrier, or a combination thereof and a channel state information reference signal that is not configured or signaled in the transmission configuration indicator state via the medium access control control element.

In various embodiments, the uplink signal comprises a user equipment dedicated physical uplink data channel and physical uplink control channel in a corresponding bandwidth part, a corresponding component carrier, or a combination thereof and a sounding reference signal resource or resource set that is not configured or signaled spatial relation information via the medium access control control element.

In one embodiment, a QCL-TypeA is included with the QCL-TypeD or the first quasi-co-location type, the QCL-TypeA is a non-zero power channel state information reference signal resource with parameter trs-info, or without trs-info and without repetition, the QCL-TypeD comprises a QCL-TypeA non-zero power channel state information reference signal resource, or a non-zero power channel state information reference signal resource with repetition.

In certain embodiments, the second quasi-co-location type comprises a synchronization signal block, a non-zero power channel state information reference signal, or a sounding reference signal.

In some embodiments, the first quasi-co-location type, the QCL-TypeD, or a combination thereof comprises a non-zero power channel state information reference signal.

Embodiments may be practiced in other specific forms. One or more of the embodiments described herein may be combined to form another embodiment. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
receiving at least one radio resource control (RRC) message that configures at least one transmission configuration indicator (TCI) state, wherein a TCI state of the at least one TCI state is used as a reference for reception of a downlink signal, transmission of an uplink signal, or a combination thereof;
receiving a medium access control control element MAC CE that activates a subset of TCI states of the at least one TCI state for use by downlink control information (DCI); and
receiving the DCI, wherein the DCI indicates a TCI state of the at least one TCI state.

2. A user equipment (UE), comprising:
at least one memory; and
at least one processor coupled with the at least one memory and configured to cause the UE to:
receive at least one radio resource control (RRC) message that configures at least one transmission configuration indicator (TCI) state, wherein a TCI state of the at least one TCI state is used as a reference for reception of a downlink signal, transmission of an uplink signal, or a combination thereof;
receive a medium access control control element (MAC CE) that activates a subset of TCI states of the at least one TCI state for use by downlink control information (DCI); and
receive the DCI, wherein the DCI indicates a TCI state of the at least one TCI state.

3. The UE of claim 2, wherein the TCI state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

4. The UE of claim 3, wherein the at least one processor is configured to cause the UE to:
in response to receiving the DCI indicating a TCI including the QCL-TypeD but not the second quasi-co-location type, apply the QCL-TypeD to the downlink signal as a spatial receive parameter, and the at least one processor is configured to cause the UE to maintain a current uplink spatial relation information for the uplink signal;
in response to receiving the DCI indicating the TCI including the second quasi-co-location type, apply the second quasi-co-location type to the uplink signal as spatial relation information, and the at least one processor is configured to cause the UE to maintain a current downlink spatial receive parameter for the downlink signal;
in response to receiving the DCI indicating the TCI including the first quasi-co-location type, apply the first quasi-co-location type to the downlink signal as a spatial receive parameter, and to the uplink signal as spatial relation information; and
in response to receiving the DCI indicating the TCI including a QCL-TypeD and a second quasi-co-location type, apply the QCL-TypeD to the downlink signal as the spatial receive parameter, and the second quasi-co-location type to the uplink signal as spatial relation information.

5. The UE of claim 4, wherein the downlink signal comprises a UE dedicated physical downlink shared channel (PDSCH) and physical downlink control channel (PDCCH) in a corresponding bandwidth part (BWP), a corresponding component carrier, or a combination thereof and a channel state information (CSI) reference signal (RS) that is not configured or signaled in the TCI state via the MAC CE.

6. The UE of claim 4, wherein the uplink signal comprises a UE dedicated physical uplink data channel and physical uplink control channel in a corresponding bandwidth part (BWP), a corresponding component carrier, or a combination thereof and a sounding reference signal (SRS) resource or resource set that is not configured or signaled spatial relation information via the MAC CE.

7. The UE of claim 4, wherein a QCL-TypeA is included with the QCL-TypeD or the first quasi-co-location type, the QCL-TypeA is a non-zero power channel state information (CSI) reference signal (RS) resource with parameter trs-info, or without trs-info and without repetition, the QCL-TypeD comprises a QCL-TypeA non-zero power CSI RS resource, or a non-zero power CSI RS resource with repetition.

8. The UE of claim 4, wherein the second quasi-co-location type comprises a synchronization signal block (SSB), a non-zero power channel state information (CSI) reference signal (RS), or a sounding reference signal (SRS).

9. The UE of claim 3, wherein the first quasi-co-location type, the QCL-TypeD, or a combination thereof comprises a non-zero power channel state information (CSI) reference signal (RS).

10. An apparatus for performing a network function, the apparatus further comprising:
at least one memory; and
at least one processor coupled with the at least one memory and configured to cause the apparatus to:
transmit at least one radio resource control (RRC) message that configures at least one transmission configuration indicator (TCI) state, wherein a TCI state of the at least one TCI state is used as a reference for reception of a downlink signal, transmission of an uplink signal, or a combination thereof;
transmit a medium access control control element (MAC CE) that activates a subset of TCI states of the at least one TCI state for use by downlink control information (DCI); and
transmit the DCI, wherein the DCI indicates a TCI state of the at least one TCI state.

11. The apparatus of claim 10, wherein the TCI state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

12. The apparatus of claim 11, wherein the downlink signal comprises a UE dedicated physical downlink shared channel (PDSCH) and physical downlink control channel (PDCCH) in a corresponding bandwidth part (BWP), a corresponding component carrier, or a combination thereof and a channel state information (CSI) reference signal (RS) that is not configured or signaled in the TCI state via the MAC CE.

13. The apparatus of claim 11, wherein the uplink signal comprises a UE dedicated physical uplink data channel and physical uplink control channel in a corresponding bandwidth part (BWP), a corresponding component carrier, or a combination thereof and a sounding reference signal (SRS) resource or resource set that is not configured or signaled spatial relation information via the MAC CE.

14. The apparatus of claim 11, wherein a QCL-TypeA is included with the QCL-TypeD or the first quasi-co-location type, the QCL-TypeA is a non-zero power channel state information (CSI) reference signal (RS) resource with parameter trs-info, or without trs-info and without repetition, the QCL-TypeD comprises a QCL-TypeA non-zero power CSI RS resource, or a non-zero power CSI RS resource with repetition.

15. The apparatus of claim 11, wherein the second quasi-co-location type comprises a synchronization signal block (SSB), a non-zero power channel state information (CSI) reference signal (RS), or a sounding reference signal (SRS).

16. A processor for wireless communication, comprising:
at least one controller coupled with at least one memory and configured to cause the processor to:
receive at least one radio resource control (RRC) message that configures at least one transmission configuration indicator (TCI) state, wherein a TCI state of the at least one TCI state is used as a reference for reception of a downlink signal, transmission of an uplink signal, or a combination thereof;
receive a medium access control control element (MAC CE) that activates a subset of TCI states of the at least one TCI state for use by downlink control information (DCI); and
receive the DCI, wherein the DCI indicates a TCI state of the at least one TCI state.

17. The processor of claim 16, wherein the TCI state comprises a second quasi-co-location type that provides uplink spatial relation information for uplink transmission, a first quasi-co-location type that provides both downlink spatial receive parameter for downlink reception and uplink spatial relation information for uplink transmission, or a QCl-TypeD that provides a downlink spatial receive parameter for downlink reception and the second quasi-co-location type that provides uplink spatial relation information for uplink transmission.

18. The processor of claim 17, where in the at least one controller is configured to cause the processor to:
in response to receiving the DCI indicating a TCI including the QCL-TypeD but not the second quasi-co-location type, apply the QCL-TypeD to the downlink signal as a spatial receive parameter, and the at least one controller is configured to cause the processor to maintain a current uplink spatial relation information for the uplink signal;
in response to receiving the DCI indicating the TCI including the second quasi-co-location type, apply the second quasi-co-location type to the uplink signal as spatial relation information, and the at least one controller is configured to cause the processor to maintain a current downlink spatial receive parameter for the downlink signal;
in response to receiving the DCI indicating the TCI including the first quasi-co-location type, apply the first quasi-co-location type to the downlink signal as a spatial receive parameter, and to the uplink signal as spatial relation information; and
in response to receiving the DCI indicating the TCI including a QCL-TypeD and a second quasi-co-location type, apply the QCL-TypeD to the downlink signal as the spatial receive parameter, and the second quasi-co-location type to the uplink signal as spatial relation information.

19. The processor of claim 18, wherein the downlink signal comprises a user equipment (UE) dedicated physical downlink shared channel (PDSCH) and physical downlink control channel (PDCCH) in a corresponding bandwidth part (BWP), a corresponding component carrier, or a combination thereof and a channel state information (CSI) reference signal (RS) that is not configured or signaled in the TCI state via the MAC CE.

20. The processor of claim 18, wherein the uplink signal comprises a user equipment (UE) dedicated physical uplink data channel and physical uplink control channel in a corresponding bandwidth part (BWP), a corresponding component carrier, or a combination thereof and a sounding reference signal (SRS) resource or resource set that is not configured or signaled spatial relation information via the MAC CE.
